(19) United States
(12) Patent Application Publication
(10) Pub. No.: US 2018/0355887 A1
(43) Pub. Date: Dec. 13, 2018

(54) CENTRIFUGAL COMPRESSOR COOLING

(71) Applicant: FRONTLINE AEROSPACE, INC., Broomfield, CO (US)

(72) Inventors: RYAN S. WOOD, BROOMFIELD, CO (US); W. GENE STEWARD, NEDERLAND, CO (US)

(21) Appl. No.: 15/837,619

(22) Filed: Dec. 11, 2017

Related U.S. Application Data
(60) Provisional application No. 62/432,435, filed on Dec. 9, 2016.

(51) Int. Cl. F04D 29/42; F02C 3/08; F02C 7/18

(52) U.S. Cl. CPC F04D 29/4206; F02C 6/06; F02C 7/18; F02C 3/08

(57) ABSTRACT

Systems, apparatuses and methods (“utilities”) for use in “internally” cooling an centrifugal compressor of a gas turbine engine so as to approximate isothermal compression and thereby increase the power and/or efficiency of the engine. In one arrangement, a centrifugal housing having fluid or coolant paths is provided to absorb heat or thermal energy generated while compressing intake air.

### CROSS REFERENCE

The present application claims the benefit of U.S. Provisional Patent Application No. 62/432,435 having a filing date of Dec. 9, 2016, the entire contents of which is incorporated herein by reference.

### FIELD

The present disclosure is directed toward centrifugal compressors. More specifically, the present disclosure is directed towards systems and methods for cooling a centrifugal or radial compressor of a gas turbine engine to reduce the temperature rise of air passing through the compressor and thereby reduce the power required by the compressor.

### BACKGROUND

A gas turbine engine extracts energy from a flow of hot gas that is produced by the combustion of gaseous or liquid fuel with compressed air. In its basic form, a gas turbine engine employs a rotary air compressor driven by a turbine with a combustion chamber disposed between the compressor and the turbine.

Principles of thermodynamics teach that when the temperature of the gases entering the turbine exceeds that entering the compressor, the turbine can deliver more power than the compressor consumes. In this regard, the engine can produce a net power output contingent upon other criteria being met. The efficiency with which the engine converts thermal energy into mechanical energy depends on many factors including compressor and turbine efficiencies, temperature and pressure levels, and the presence or absence of enhancements such as regeneration and compressor air stream cooling (intercooling). The power produced is proportional to the efficiency as well as the mass flow rates of air and fuel. Turboshaft engines deliver mechanical power through a rotating output shaft. Turbojet or turbofan engines require only enough turbine power to operate the compressor (with or without a fan) and the excess fluid power is available in the form of jet thrust.

Conventional gas turbine engines operate approximately according to the ideal “Gas Turbine” or “Brayton” cycle which, by definition, embodies reversible adiabatic (without heat transfer) compression of atmospheric air, addition of heat at constant pressure, reversible adiabatic expansion through a turbine back to atmospheric pressure, and finally exhausting to the atmosphere. Deviations from the ideal cycle (e.g., irreversibilities) arise due fluid friction and turbulence, inefficiencies in compressors and turbines, combustion heat loss, and the like.

The Ericsson Cycle patented in 1830 embodies constant pressure regeneration, isothermal compression, and isothermal expansion (reheat), but proposes no means of accomplishing either isothermal compression or expansion. The ideal Ericsson Cycle has “Carnot” efficiency (classical thermodynamics proves that no ideal heat engine operating between given source and sink temperatures can exceed Carnot Cycle efficiency). While the visionary scientists of the nineteenth century, Nicolas Carnot, James Joule, Lord Kelvin, Rudolf Clausius, and Ludwig Boltzman who developed the new branch of science (i.e., Thermodynamics) as well as modern engineers have recognized the benefits of isothermal compression and turbine reheat, no known practical method of achieving or approximating approximate isothermal compression (or expansion) has been perfected.

One attempt to remove compression heat from the engine (“external intercooling”) diverts air out of each stage of an axial compressor, passes the air through a separate heat exchanger/radiator, and re-injects the cooled air into the inlet of the next compressor stage. However, the circuitous piping and multiple changes in flow direction could defeat much, or all of any thermodynamic advantage of external intercooling.

Another disadvantage of external-intercooling is how the increased complexity of such systems significantly increases the weight of a turbine engine. This is especially relevant to aircraft applications where turbine engines are often utilized due to their high power to weight ratio. That is, in most cases, gas turbine engines are considerably smaller and lighter than reciprocating engines of the same power rating. For this reason, turboshaft engines are used to power almost all modern helicopters. However, incorporation of external intercoolers into turbine engines would result in a significant addition of weight which would more than offset any power gain benefits for such applications.

### SUMMARY

Provided herein are systems and methods (i.e., utilities) that implement what is termed “Approximated Isothermal Compression” (AIC) in a centrifugal compressor of a gas turbine engine. AIC provides significant improvements in heat rate and power (10-25% depending on turbine design) by implementing centrifugal or radial compressor cooling that lowers the work required by a turbine engine to compress air. In various utilities, a liquid coolant is supplied to a compressor housing that houses a centrifugal compressor. In various aspects, which may be utilized together and/or independently, the liquid coolant is the fuel utilized by the combustor of the turbine engine. Use of the fuel as the coolant makes the utilities well suited for use in aircraft applications as the aircraft are not required to carry separate coolant and/or complex plumbing, pumps and radiators to reject heat from the coolant.

Disclosed herein are various apparatuses, systems and methods to achieve what will be referred to herein as “external intercooling”. External intercooling is the cooling of a centrifugal compressor airstream without disrupting the normal flow path of the airstream through the centrifugal compressor. Such external cooling can expel much of the compression heat in the centrifugal compressor to approximate isothermal compression in the centrifugal compressor stage and thereby reduce the consumption of power by the centrifugal compressor. That is, various aspects of the presented inventions are directed to practical and effective means of expelling much of the compression heat in order to reduce the consumption of power by the compressor. While cooling of the centrifugal compressor reduces the compressor discharge temperature, such cooling can cause an increase in the fuel flow rate needed to maintain the turbine inlet temperature at its set value, the incremental increase in the required combustion heat is the same as the incremental decrease in compressor specific work. Thus, the turbine net specific work (i.e., total turbine specific work minus compressor specific work) increases by that same amount (i.e., the output power increases by exactly the same amount as the increase in combustion heat rate). As efficiency is given by net-power/combustion-heat-rate, efficiency actually increases because the same increment is added to the numerator and denominator of a fraction less than 1.0 (i.e., this causes an increase in the value of the fraction).

One of the utilities disclosed herein includes specially designed compressor impellor housing that absorbs thermal energy which can then be transferred away from the airflow through the compressor. The apparatus generally includes an annular compressor housing including inside and outside surfaces, and inlet and outlet ends, such that air generally moves in an air flow direction from the inlet end towards the outlet end. A sidewall extends between the inlet and outlet. Formed within the sidewall are one or more fluid path that allow for circulating fluid (i.e., coolant) though the housing. In one arrangement, fuel of a gas turbine engine using the compressor housing is used as the coolant. This arrangement allows for both removing heat from the compressed air, thereby reducing the power needed by the compressor to compress the intake air, and preheating the fuel prior to combustion. In another arrangement, the coolant may be a closed system where coolant is circulated through the compressor housing and the heat absorbed from the coolant is rejected using, for example, a radiator. In this arrangement, the heated coolant may be utilized to preheat the fuel using, for example, a separate heat exchanger.

### BRIEF DESCRIPTION OF THE DRAWINGS

FIG. 1 illustrates a perspective view of a gas turbine engine.

FIG. 2 shows a side view of the engine of FIG. 1.

FIG. 3 shows an end view of the engine of FIG. 1.

FIG. 4 shows an exploded view of an axial compressor assembly.

FIG. 5 shows an exploded view of a portion of a centrifugal compressor assembly.

FIG. 6A shows a perspective view of an internally cooled centrifugal compressor housing.

FIG. 6B shows a side view of an internally cooled centrifugal compressor housing.

FIG. 6C shows a cross-sectional view of an internally cooled centrifugal compressor housing.

FIG. 7 shows an internally cooled compressor housing used for an aircraft application.

FIG. 8 shows an internally cooled compressor housing used with an external cooling system.

### DETAILED DESCRIPTION

Reference will now be made to the accompanying drawings, which assist in illustrating the pertinent features of the various novel aspects of the present disclosure. Although described primarily with respect to compressor cooling systems, apparatuses and methods (i.e., utilities) that may or may not be combined with recuperation and used with a turbine engine (e.g., in aircraft applications), aspects of the utilities are applicable to centrifugal compressors that may be utilized for gas compression applications such as gas pipeline compressors. In this regard, the following description is presented for purposes of illustration and description. Furthermore, the description is not intended to limit the inventive aspects to the forms disclosed herein. Consequently, variations and modifications commensurate with the following disclosures are within the scope of the present inventive aspects.

The presented centrifugal compressor cooling systems and methods discussed herein may be utilized with a variety of different gas turbine engines. The present description describes the centrifugal compressor cooling utilities in relation to the Rolls-Royce Model 250 family of engines (US military designation T63). However, discussion of the presented utilities with the Model 250 engine is presented by way of illustration and not by way of limitation. The presented utilities may be unitized with various gas turbine engines including other aircraft engines and ground based engines as well as other centrifugal compressors.

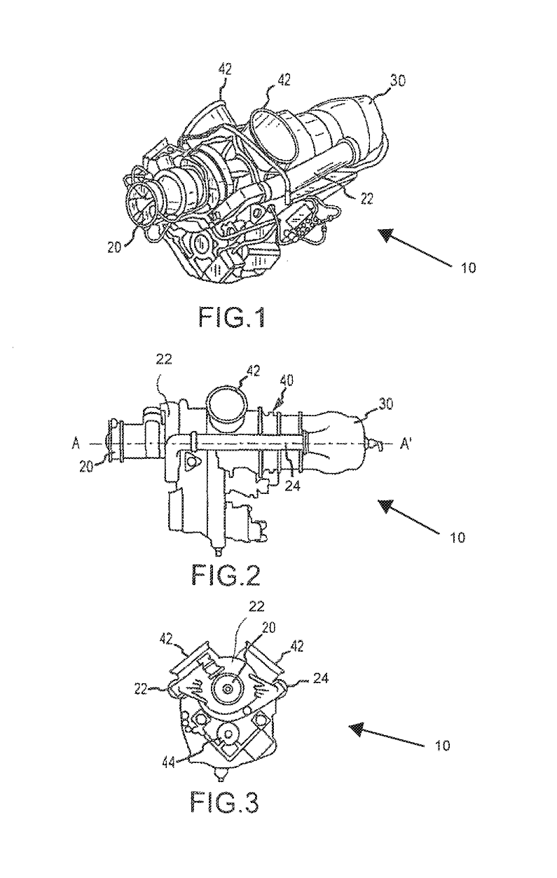

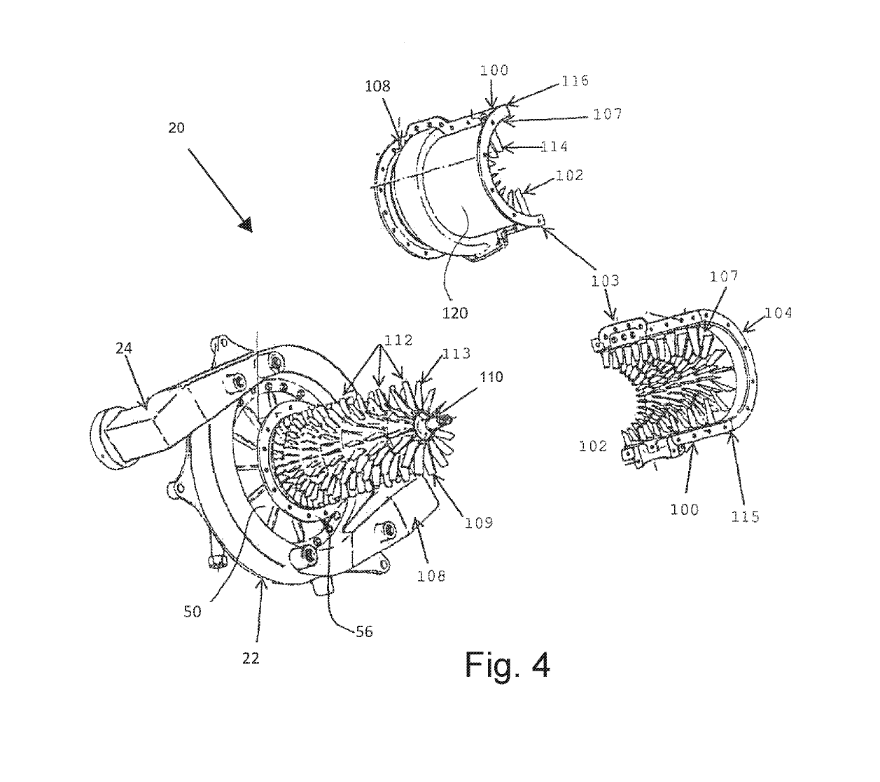

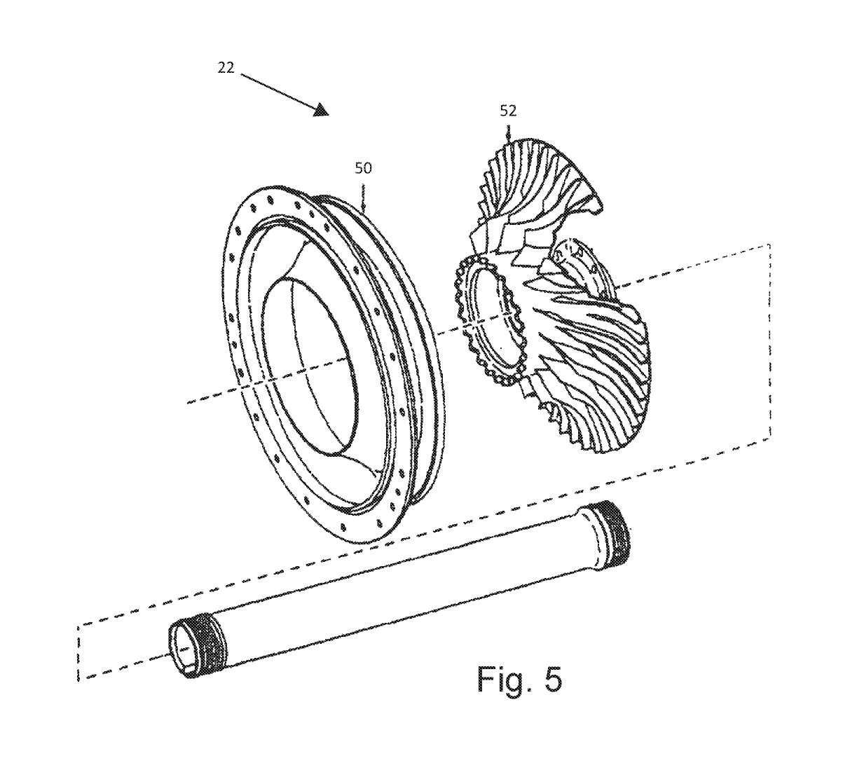

The Model 250 engine 10, as schematically shown in the perspective, side and front views of FIGS. 1-3, utilizes what is sometimes referred to as a “trombone” engine configuration whereby air enters the intake of an axial compressor 20 and passes through an axially aligned centrifugal compressor 22 in a conventional fashion, but whereby compressed air leaving the compressors 20, 22 is ducted rearwards around the turbine system via external air ducts 24. That is, unlike most other turboshaft engines, the compressors 20 and 22, combustion chamber or combustor 30 and turbine section or stage 40 are not provided in an inline configuration with the compressors at the front and the turbine at the rear where compressed air flows axially through the engine. Rather, in the Model 250 engines, the engine air from the forward compressor 20 is channeled through the external compressed air ducts 24 on each side of the engine 10 to the combustor 30 located at the rear of the engine. The exhaust gases from the combustor 30 then pass into a turbine stage 40 located intermediate the combustor 30 and the compressor 20. The exhaust gases are exhausted mid-engine in a radial direction from the turbine axis A-A of the engine, through two exhaust ducts 42. A power take-off shaft 44 connects the power turbine of the turbine stage to a compact reduction gearbox (not shown) located inboard between the compressor and the exhaust/power turbine system.

Gas turbine engines are described thermodynamically by the idealized Brayton cycle, in which air is compressed isentropically, combustion occurs at constant pressure, and expansion over the turbine occurs isentropically back to the starting pressure. In practice, friction and turbulence cause non-isentropic compression. Specifically, the compressor tends to deliver compressed air at a temperature that is higher than ideal. Furthermore, pressure losses in the air intake, combustor and exhaust reduce the expansion available to provide useful work. By some estimates, up to half of the power produced by the engine goes to powering the compressor.

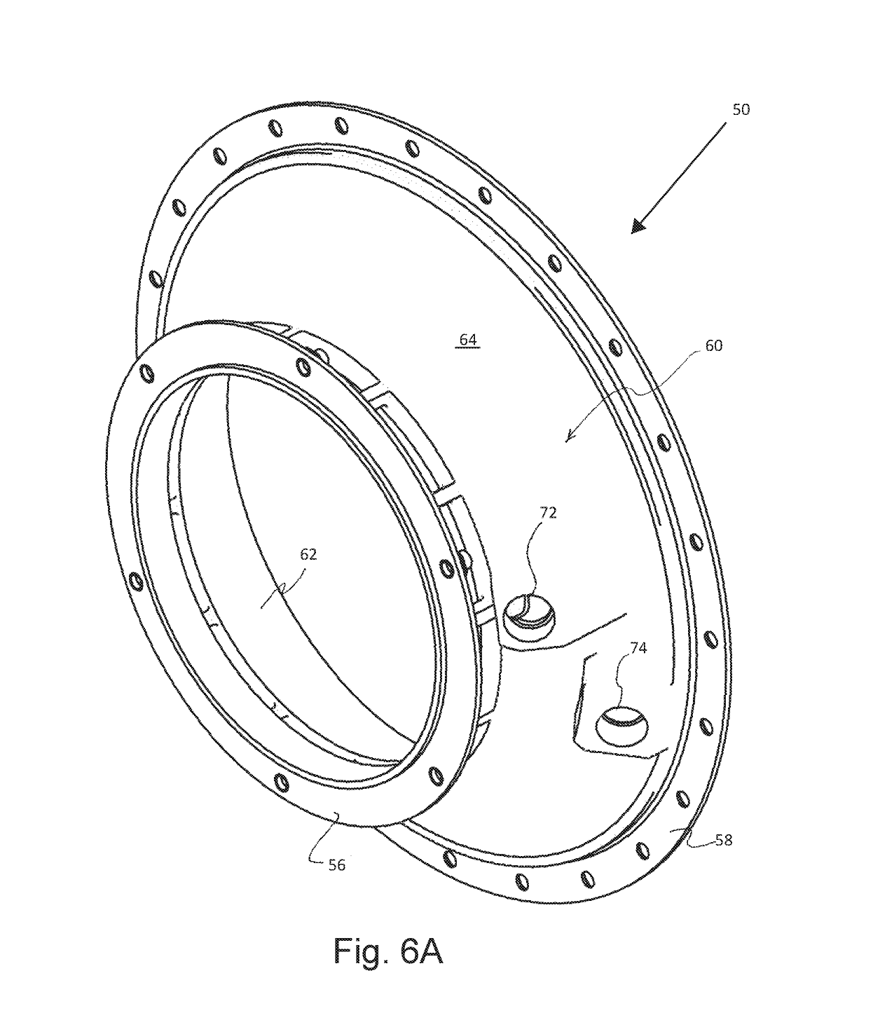

FIG. 4 illustrates an exploded view of the axial compressor 20. Broadly, the compressor 20 may include a rotor structure 109 and a stator structure 103. The rotor structure 109 includes a rotating shaft 110 that extends through the engine 10 to the turbine stage 40. The rotating shaft 110 include multiple attached rotor sections 112 spaced along the length of the rotating shaft 110, each of which include a series or set of rotor blades 113 extending away from the rotating shaft 110. The stator structure 103 also include a stator housing or axial compressor housing 100 having inside and outside surfaces 107, 120, inlet and outlet ends 104, 108 and a central axis (not shown) running through the center of the axial compressor housing 100. As seen, the axial compressor housing 100 may be divided into first and second halves 115, 116. A plurality of stator rows or sections 102 may be disposed on the inside surface 107, each of which may include a series or set of stator vanes or blades 114.

In assembly, the first and second halves 115, 116 of the housing may be interconnected together (e.g., via bolts and apertures, not labeled) such that the stator casing 100 surrounds the shaft 110 and rotor sections 112 and a longitudinal axis (not shown) of the rotating shaft 110 is coincident with the central axis of the axial compressor housing 100. At this point, the stator sections 102 and rotor sections 112 may alternate and the rotor sections 112 may be operable to rotate in the spaces between the stator sections 102. The angles of each of the stator and rotor sections 102, 112 may also alternate. Furthermore, the various stator and rotor sections 102, 112 may have different spacing (e.g., blade density) as well as different angles from the previous rows of blades.

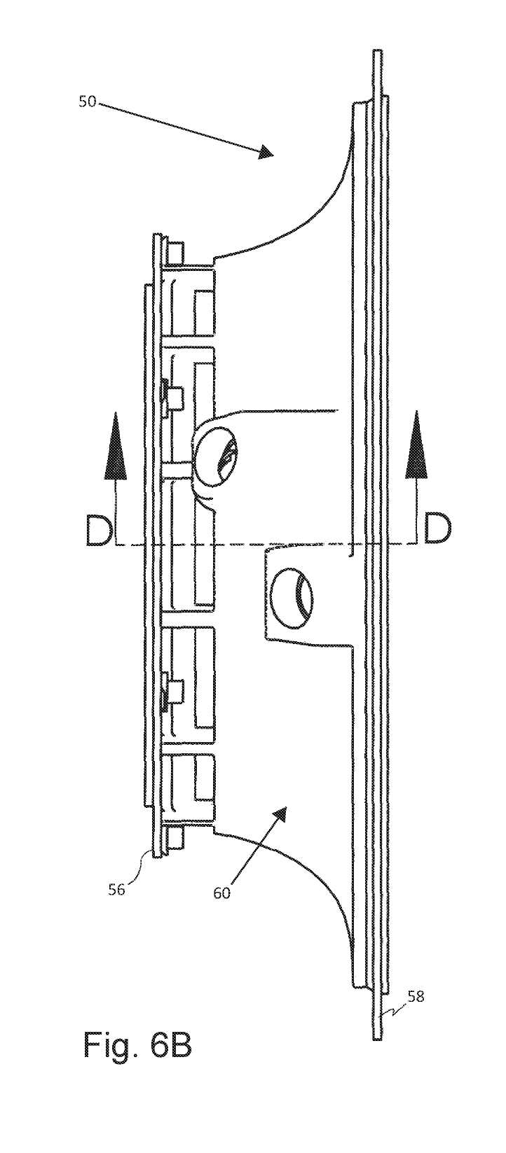

As further shown in FIG. 4, the outlet end 108 of the axial compressor housing defines a flange having a plurality of bolt apertures. This allows the axial compressor casing to be firmly attached to an inlet flange 56 of an impellor housing 50 of the centrifugal compressor 22. In this regard, air compressed by the axial compressor 20 passes out of the outlet end 108 and into the inlet end of the centrifugal compressor 22. A portion of the centrifugal compressor 22 is illustrated in FIG. 5 as shown, the centrifugal compressor 22 includes an impellor 52 having a plurality of vanes. The impeller 52 is interconnected to the shaft 110 and, in the present embodiment, co-rotates with the rotor blades of the axial compressor. When assembled, the impeller 52 is encased within the housing 50. In operation, the impeller 52 further compresses the air received from the axial compressor. That is, during operations the rotor blades 113 turn relative to the stator blades 114, air advances from the inlet end 104 of the stator casing 100 through the multiple rows (e.g., stages) of stator blades 114 and rotor blades 113 and discharges through the compressor outlet end 108 into the centrifugal compressor 22 where it is further compressed by the impellor 52 of the centrifugal compressor 22 after which it is discharged through a diffuser into the air ducts 24. See FIG. 4 4. As the air advances through the axial compressor 20 and centrifugal compressor 22, the air may be compressed from ambient pressure to over 100 psi. However, the compression pressure may vary between different engines. In addition to being compressed, the friction of the blades (e.g., rotor blades and impellor vanes) rotating and air passing over the blades applies significant heat to the air. For instance, air entering at ambient temperature of approximately 518.67° R may be heated to a temperature over 1000° R. The temperature increase may vary between different engines.

The increase in the temperature of the air as it passes through the compressors 20 and 22 results in the air expanding and thus working against its compression. Stated otherwise, the addition of heat to the compressed air is parasitic and requires that the engine supply more compression power to achieve the desired output pressure. Accordingly, utilities disclosed herein are directed to reducing the temperature gain of air flowing through the centrifugal compressor to reduce compression power requirements and thereby increase the available shaft output power of the engine.

Aspects of the present disclosure are based on the realization that significant reduction in the temperature rise of the compressed intake air may be achieved via cooling the centrifugal compressor housing. In various arrangements near isothermal compression may be achieved through the centrifugal compressor via centrifugal compressor housing cooling which reduces the power requirements of the compressor improving overall efficiency of the engine. Along these lines, it is been determined that the centrifugal compressor housing 50 may be formed by a plurality of internal fluid paths through which coolant may be circulated. The coolant passing through the compressor housing 50 removes thermal energy from the compressor housing lowering its temperature and thereby permits heat exchange between the hot intake air passing through the interior of the cooled housing.

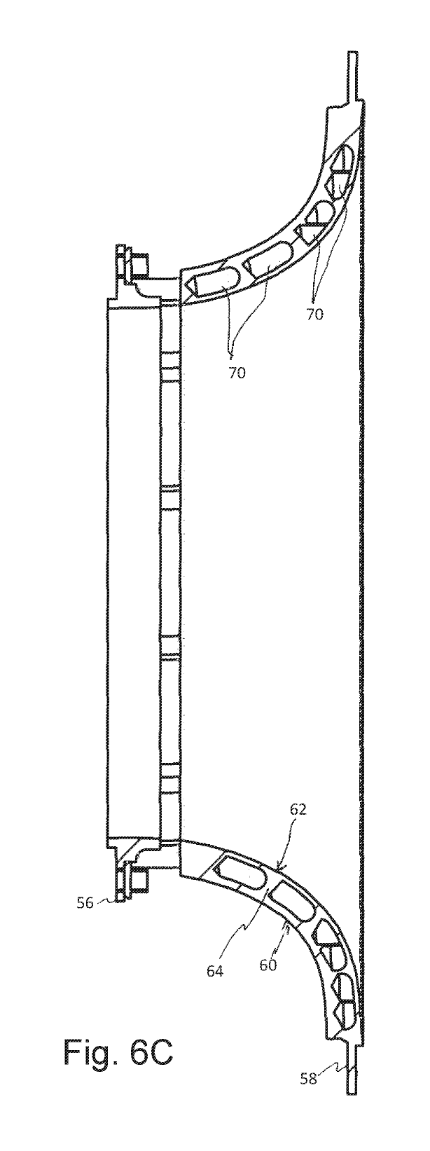

FIGS. 6A, 6B and 6C illustrated perspective, side, and cross-sectional views, respectively, of an internally cooled centrifugal compressor housing 50. As shown, the compressor housing 50 includes an annular inlet flange 56 and an annular outlet flange 58 both of which include a plurality of apertures for attachment to mating components of a gas turbine engine or other compressor system. An annular sidewall 60 extends between the inlet flange 56 and the outlet flange 58. The inlet flange 56 defines a central inlet or aperture for receiving inlet air (e.g., upstream gas) and the outlet flange defines a central outlet aperture for outputting outlet air (e.g., downstream gas) compressed by an impeller encased within the housing 50. As shown, the inlet aperture has a first diameter that is typically smaller than a second diameter of the outlet aperture. Accordingly, an inside surface 62 of the sidewall transitions between the first smaller diameter and the second larger diameter of the housing 50. The curvature of the inside surface 62 is typically configured to substantially match the shape of the impeller encased within the housing 50. That is, the inside surface 62 is substantially similar in shape to a surface defined by rotation of the impeller 52. It will be appreciated that the exact shape of the inside surface 62 may be varied based on the configuration of the impeller 52. An outside surface 64 of the sidewall 60 is spaced from the inside surface and may, but need not, generally correspond to the shape of the inside surface 62.

Within the sidewall 60 between the inside surface 62 an outside surface 64 are plurality of fluid passages or fluid paths 70. The fluid paths 70 extends between a first inlet/outlet port 72 and a second inlet/outlet port 74 formed into the outside surface 64 of the housing 50. Accordingly, appropriate fluid conduits may be connected to the ports 72, 74 to circulate fluid through the housing 50 while the impeller is operating therein. Such fluid flow permits the removal of thermal energy from the housing which in turn reduces the temperature of the air being compressed by the impeller. In a further embodiment, surface features may be added to the interior surface of the housing (e.g., grooves, ridges, vanes, etc.) to increase the surface area of the interior surface and thus increase the heat exchange of the cooled housing.

The exemplary fluid path 70 is a spiraled or roughly helical fluid path that extends multiple rotations around the center axis of the housing. Though using the word helical, it will be appreciated that the radius and or pitch of the spiral may be varied throughout the sidewall. In an embodiment utilizing a spiraled or helical type fluid path, the fluid path may be a single passage or a manifold of passages that extends between the first and second ports 72, 74. As shown in FIG. 6C, the cross-sectional shape of the singular spiral fluid path or passage is varied depending on its location within the sidewall. The size and shape of the fluid path may be selected to provide desired thermal properties and/or to facilitate manufacture. Further, the shape (e.g., cross-sectional, diameter, etc.) of the fluid path(s) may vary along their length. Though illustrated utilizing a single continuous spiral fluid path, it will be appreciated that fluid paths of different configurations may be utilized within the sidewall. For instance, annular manifolds may be defined proximate to the inlet and outlet flanges which are connected by a plurality of fluid paths that flow therebetween. In such an arrangement, the fluid paths may define a heat exchanger that is of the crossflow variety and/or counterflow variety. What is important is that the cooling fluid may be circulated between the inlet and outlet ports and along the length of the sidewall to remove thermal energy from the housing. It will be further appreciated that various pumps may be included to circulate the fluid through the housing. In some embodiments, the heated fluid may be directed to an external heat exchanger or radiator (not shown) where the heat extracted from the compressor housing may be rejected, for example, into the atmosphere or another fluid or process.

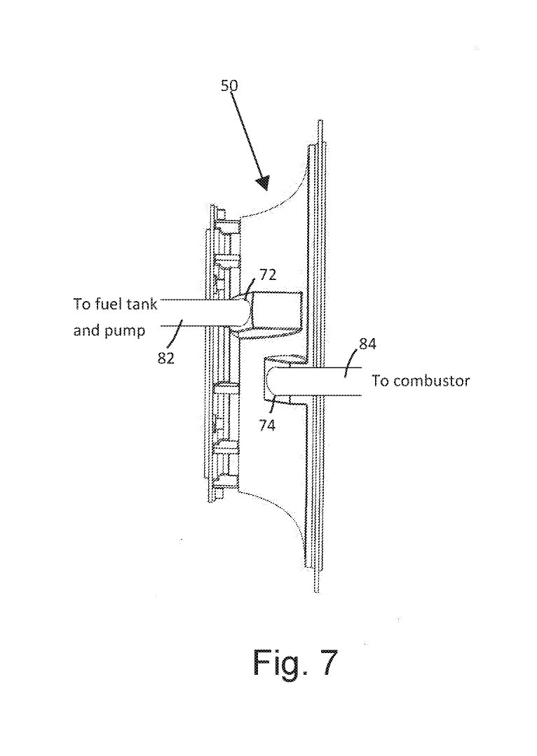

In an embodiment well suited for use in aircraft applications, the first port 72 may be connected to the fuel tank of the aircraft via a first conduit 82. See FIG. 7. In such an arrangement, the second port 74 may be connected to the combustor via a second conduit 84. In this embodiment, the fuel supply of the aircraft essentially serves as the coolant for the centrifugal compressor just prior to combustion. A dual benefit can be achieved by using the fuel as a coolant and preheating the fuel to a more thermodynamically favorable combustion temperature can thus be achieved. This typically requires that the fuel coolant be provided under a predetermined pressure. This embodiment reduces the need of having a separate coolant cooling system. That is, no pump or radiators are required to reject heat from the coolant used to cool the compressor housing. Rather, the heated fuel is simply burned in the combustor. Heat rejection via a separate coolant cooling system may be reduced or eliminated.

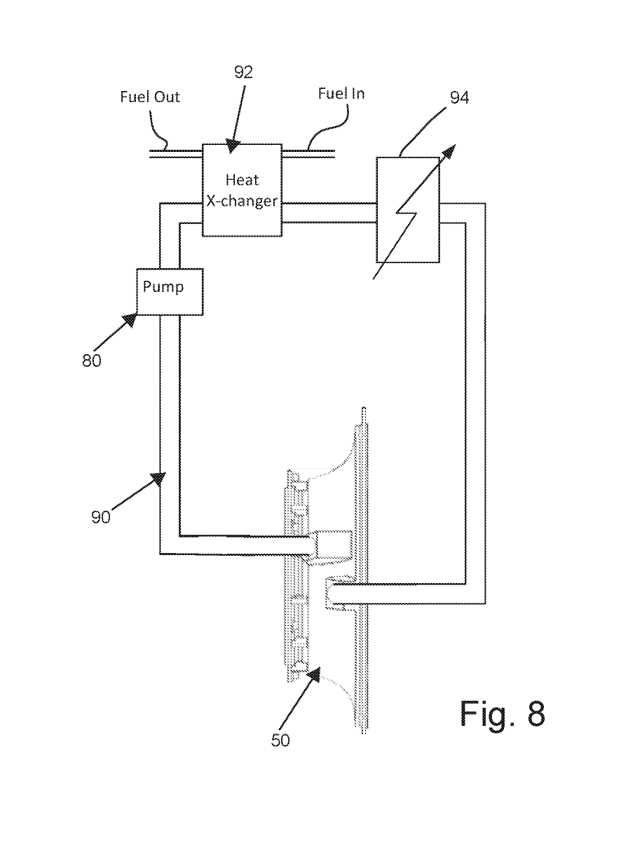

In another embodiment, a secondary coolant loop is incorporated. See FIG. 8. In this embodiment, a pump 80 is incorporated to pump coolant in through a coolant loop 90 through the compressor housing 50 and one or more heat rejection devices. In one embodiment, the coolant loop 90 passes through a heat exchanger 92 to preheat fuel the passes through the heat exchanger 92. Additionally or alternatively, the coolant loop 90 may also incorporate a radiator 94 to reject heat from the coolant after it has passed through the compressor housing 50. In such an embodiment, the benefit of heating the fuel is realized and the heat exchange between the coolant and the fuel facilitates heat rejection from the coolant.

The impeller housing 50 including the internal fluid path(s) 60 may, in one embodiment, be formed using a three-dimensional printing technique. For instance, the impellor housing may be formed in a direct metal laser sintering (DMLS) process. DMLS is an additive manufacturing technique that uses a carbon dioxide laser fired into a magnesium substrate to sinter powdered material (typically metal), aiming the laser automatically at points in space defined by a 3D model, binding the material together to create a solid structure. Thus, any 3D model may be formed in a DMLS process. Alloys used in the process include, without limitation, 17-4 and 15-5 stainless steel, maraging steel, cobalt chromium, inconel 625 and 718, and titanium Ti6A14V. It will be appreciated that any appropriate printing process may be utilized. Alternatively, the impeller housing may be machined where, for example, the inner surface is connected (e.g., bonded, welded, etc.) to the sidewall containing milled fluid paths.

The ability to provide cooling to the impellor housing can significantly reduce the compressor air outlet temperature. That is, compressed air temperature rise may be significantly reduced in comparison to the temperature rise in a conventional turbine engine. This reduced compressor output temperature is a modification of the basic gas turbine Brayton cycle. In a theoretical limit, compression may be done at constant temperature or ‘isothermal’ compression with the remainder of the cycle being the same as the Brayton cycle—constant pressure combustion and isentropic expansion. This modified cycle is referred to herein as the ‘Approximated Isothermal Compression’ AIC cycle, which utilizes isothermal or reduced temperature rise compression.

To improve engine efficiency and power output, any appropriate manner of achieving regeneration may be included along with the apparatuses and methods disclosed herein for cooling a centrifugal compressor and/or the airstream flowing therethrough. Regeneration is the use of a heat exchanger to transfer heat from an engine exhaust stream to the compressor discharge air (thus preheating the compressor discharge air) in a turbine engine such that less fuel energy is required to achieve the required turbine inlet temperature for the compressed air. By recovering some of the energy usually lost as waste heat, a regenerator can make a gas turbine engine significantly more efficient. Such a system is disclosed in U.S. patent application Ser. No. 12/650,857, entitled “Recuperator for Gas Turbine Engines,” which in incorporated herein by reference.

What is claimed is:

1. A housing for a centrifugal or radial compressor of a gas turbine engine, comprising:
an annular inlet flange for upstream gas connection having a central inlet aperture, said annular inlet flange having a first diameter;
an annular outlet flange for downstream gas connection having a central outlet aperture, said annular outlet flange having a second diameter greater than said first diameter and wherein a reference line passing between the centers of said central inlet aperture and said central outlet aperture defines a centerline axis of the housing;
an annular sidewall extending between said annular inlet flange and said annular outlet flange, said sidewall including:
an annular inside surface that transitions between said first diameter and said second diameter, wherein said annular inside surface is configured to receive a centrifugal impellor of the gas turbine engine;
an outside surface spaced from said inside surface; and
a fluid path disposed within said sidewall between said inside surface and said outside surface, wherein said fluid path extends between a first fluid port in said outside surface proximate to said annular inlet flange and a second fluid port in said outside surface proximate to said annular outlet flange.

2. The housing of claim 1, wherein said annular inside surface comprises a curved surface between said annular inlet flange and said annular outlet flange.

3. The housing of claim 1, wherein said annular inside surface is complementarily shaped to an outside surface defined by rotation of the centrifugal impellor.

4. The housing of claim 1, wherein said fluid path comprises a spiral or helical fluid path.

5. The housing of claim 4, wherein said helical fluid path between said first fluid port and said second fluid port comprises at least one full rotation about said centerline axis.

6. The housing of claim 5, wherein said helical fluid path comprises at least two full rotations about said centerline axis.

7. The housing of claim 1, wherein said fluid path comprises a plurality of cooling passages within said sidewall.

8. The housing of claim 7, wherein said cooling passages form one of a parallel-flow, cross-flow, a counter-flow, or a cross-counter-flow pattern between said first fluid port and said second fluid port.

9. The housing of claim 1, wherein said annular inside surface further comprises groves ridges or other geometries that increase a surface area of said annular inside surface.

10. A gas turbine engine comprising:
a centrifugal impellor to compress intake air;
a combustor to combust fuel with compressed intake air;
a turbine in flow communication with said combustor; and
a compressor housing surrounding said centrifugal compressor having:
an annular sidewall extending between an annular inlet flange having a first diameter and an annular outlet flange having a larger second diameter, said sidewall including:
an annular inside surface that transitions between said first diameter and said second diameter, wherein said annular inside surface is configured to receive said centrifugal impellor;
an outside surface spaced from said inside surface; and
a fluid path disposed within said sidewall between said inside surface and said outside surface, wherein said fluid path extends between a first fluid port in said outside surface proximate to said annular inlet flange and a second fluid port in said outside surface proximate to said annular outlet flange.

11. The gas turbine engine of claim 10, further comprising:
a fuel tank fluidly connected to said combustor via said fluid path.

12. The gas turbine engine of claim 11, further comprising:
a first fluid conduit extending between said fuel tank and one of said first fluid port and said second fluid port and a second fluid conduit extending between the other of said first fluid port and said second fluid port and said combustor.

13. The gas turbine engine of claim 11, further comprising:
a pump for pumping fuel through said fluid path at a predetermined pressure.

14. The gas turbine engine of claim 10, wherein said fluid path comprises a plurality of cooling passages within said sidewall.

15. The gas turbine engine of claim 14, wherein said fluid path comprises one of:
a helical path;
a cross-flow path;
a counter-cross-flow path;
a parallel path and
a counter-flow path.

16. The gas turbine engine of claim 14, further comprising:
a coolant loop connected to the first port and the second port, wherein a pump pumps coolant through the coolant loop and through the fluid path.

17. The gas turbine engine of claim 17, wherein the coolant loop further comprises:
a heat exchanger connected to a a fuel pathway, wherein fuel removes thermal energy from said coolant in said coolant loop.

18. The gas turbine engine of claim 18, wherein the coolant loop further comprises:
a radiator for rejecting heat from the coolant.

19. A method for use with a centrifugal compressor of a gas turbine engine, comprising:
rotating an impellor within a compressor housing to compress intake air between an inlet of the housing and an outlet of the housing;
circulating fluid through at least a first passage disposed within a sidewall of the compressor housing to remove thermal energy from the housing and air compressed by the impellor.

20. The method of claim 20, wherein circulating fluid comprises:
circulating fuel for use in a combustor of the gas turbine engine through the fluid path, wherein the fuel is circulated under a predetermined pressure.
